(19) United States
(12) Patent Application Publication
(10) Pub. No.: US 2015/0095210 A1
(43) Pub. Date: Apr. 2, 2015

(54) MERCHANT LOAN MANAGEMENT AND PROCESSING

(71) Applicants: Brian Grech, San Francisco, CA (US); Ashish Nayyar, San Jose, CA (US); Brian M. Hale, San Jose, CA (US)

(72) Inventors: Brian Grech, San Francisco, CA (US); Ashish Nayyar, San Jose, CA (US); Brian M. Hale, San Jose, CA (US)

(21) Appl. No.: 14/039,606

(22) Filed: Sep. 27, 2013

(51) Int. Cl. G06Q 40/02

(52) U.S. Cl. CPC G06Q 40/025
USPC 705/38

(57) ABSTRACT

Methods and systems are provided for determining creditworthiness, such as for online merchants. For example, a system can comprise one or more memories that store sales performance information regarding an online merchant. One or more hardware processors can be in communication with the one or more memories and can be operable to access the sales performance information in the one or more memories. The one or more hardware processors can be further operable to determine, at least in part from the sales performance information, a creditworthiness of the online merchant.

### BACKGROUND

1. Technical Field

The present disclosure generally relates to electronic commerce and, more particularly, relates to methods and systems for merchant loan management and processing, such as determining creditworthiness for online merchants.

2. Related Art

Online selling is very popular. Online sellers such as eBay offer a wide range of products that can be easily ordered and then delivered to the purchaser's doorstep, usually within a few days. Such products are typically comparable in price to the same products when purchased from brick-and-mortar stores. Indeed, such products can be substantially lower in price with respect to those purchased from brick-and-mortar stores, even when the cost of shipping is taken into account. Thus, when the convenience of ordering online is considered, the use of such online sellers provides an attractive alternative to traditional brick-and-mortar store shopping.

Online sellers such as eBay can facilitate sales operations for a large number of individual merchants. The individual merchants can be individuals, such as sole proprietorships, small companies, or large companies. Just about any person or company can sell on eBay.

Credit can be an important tool for businesses, such as online merchants. Credit can, if used wisely, leverage an online merchant's resources so as to allow the online merchant to increase profits. For example, credit can allow an online merchant to purchase inventory, advertise products, pay employees, and otherwise conduct the online merchant's business operations.

Creditworthiness is often a factor in making business decisions. Creditworthiness can determine whether or not a merchant can obtain credit and can determine, to a substantial extent, the cost of credit to the merchant. Although contemporary methods have proven generally satisfactory for determining creditworthiness, such contemporary methods exhibit characteristics that generally detract from their overall utility and desirability.

### BRIEF DESCRIPTION OF THE DRAWINGS

The included drawings are for illustrative purposes and serve only to provide examples of possible systems and methods for the disclosed merchant loan management and processing. These drawings in no way limit any changes in form and detail that may be made to that which is disclosed by one skilled in the art without departing from the spirit and scope of this disclosure.

FIG. 1 is a block diagram of a computing system that is adapted for implementing one or more examples of processes involving activities with respect to merchant loan management and processing, according to an embodiment.

FIG. 2 is a block diagram of an example of a computer system suitable for implementing on one or more devices of the computing system in FIG. 1, according to an embodiment.

FIG. 3 is a block diagram of a system for merchant loan management and processing, according to an embodiment.

FIG. 4 is a flow chart of a method for merchant loan management and processing, according to an embodiment.

### DETAILED DESCRIPTION

According to an embodiment, methods and systems can provide enhanced creditworthiness determination, such as for online merchants. Information not typically used to determine creditworthiness can be evaluated by the system, such as to determine if an online merchant's creditworthiness has changed over time. This enhanced assessment of creditworthiness can be used, at least in part, to determine whether or not to extend credit (or further credit) to an online merchant. Such credit can include, for example, a cash payment to the online merchant, as well as deferred payment of listing fees, deferred payment of commissions, prepayment of shipping fees, and the like. Any desired combination of such methods as disclosed herein and traditional methods for determining creditworthiness can be used.

Although the methods and systems disclosed herein are discussed as being applicable to determining the creditworthiness of online merchants, such discussion is by way of example only, and not by way of limitation. Those skilled in the art will appreciate that the methods and systems disclosed herein can be used to determine credit worthiness generally, such as with respect to various people and businesses.

According to an embodiment, cyclic, e.g. seasonal, information can be used to determine creditworthiness. For example, cyclic costs (such as product costs, labor costs, and shipping costs), cyclic market behavior, trends, and the like can be used, at least in part, to determine creditworthiness. For example, the system can automatically evaluate cyclic or changing costs or other business measures to identify costs of inventory and/or to determine business growth rate and creditworthiness.

For example, inventory can rise and fall cyclically or seasonally for some products. Such changing inventory can provide an indication of the business health of an online merchant. Such rising and falling can be compared to similar time periods, e.g., seasons or previous years, and/or can be normalized (adjusted to account for the seasonality or cyclic nature of the product) and then compared to other time periods of the same year.

According to an embodiment, any available information can be used to determine creditworthiness. Such information can be nontraditional information (information that is not typically used to determine the creditworthiness of an online merchant). For example, an online merchant's ratings, listing history, sales history, online practices, personal information, and the like can be used to determine creditworthiness. An online seller, such as eBay, or a payment provider, such as PayPal, can thus use such information to determine the online merchant's creditworthiness. Thus, creditworthiness can be determined by an online seller or payment provider. Creditworthiness can be determined by any business entity, system, or device.

Such information can be information is that readily available to the online seller or payment provider, for example. An online seller, such as eBay or a payment provider, such as PayPal can use such information from their own databases, such a sales database or a payment database, to at least partially determine creditworthiness. Such information can be obtained from any available source.

According to an embodiment, an online merchant can be scored for likelihood of success and/or likelihood of failure to help determine creditworthiness. The score can be a measure of the online merchant's likelihood of success or likelihood of failure that is based on such factors as sales volume, sales growth rate, risks, prior debt, and debt repayment. For example, each of these factors can be weighted and given a numerical value. Higher weights can be indicative of greater importance of the factors. Higher numerical values can be indicative that the factors are positive, e.g., more likely to result in success of the online merchant. For example, higher sales volumes, higher sales rates, lower risks, lower prior debts, and faster debt repayments can result in higher numerical values corresponding for an online merchant. The numerical values can be summed to provide the score. Higher scores can better indicate the online merchant's potential creditworthiness.

According to an embodiment, the likelihood of success or failure can be predicted by determining what the online merchant has in common with other online merchants who have succeeded or failed. Creditworthiness can be determined, at least in part, based upon one or more traits that the online merchant has in common with one or more failed merchants similar to the online merchant. For example, the online merchant can be compared to other online merchants of similar size, location, years in business, items being sold, etc. The criteria can be criteria that clearly relate to business success or failure, such as sales, debt, advertising budget, experience of managers, returns, adjustments, and the like. The criteria may not obviously relate to business success, such as type of product, type of business, number of products, age of the business, weather at the business location, colors used in website, and the like.

Thus, an online merchant who has much in common with other online merchants who have succeeded and/or has little in common with online merchants who have failed, can be consider likely to succeed and therefore can be considered creditworthy. Conversely, an online merchant who has much in common with other online merchants who have failed and/or little in common with online merchants who have succeeded, can be consider likely to fail and therefore not creditworthy. For example, if other online merchants that have failed have a high debt to sales ratio, then a high debt to sales ratio can be considered to be an indicator that an online merchant is not creditworthy. The information used to determine what the online merchant has in common with other online merchants can be information that is readily available to and/or proprietary with respect to the system, e.g., with respect to the online seller or payment provider.

The system can use unique sources of personal, business, and transactions information, such as information that is not commonly available to credit reporting agencies. For example, such information can be available only to an online seller or payment provider. This information can be used, at least in part, to determine an online merchant's risk of failure. Such information can include demographic information, social information, information that is readily available to an online seller or payment provider (such as information from a database of an online seller or payment provider), information that is purchased by or otherwise obtained by the online seller or payment provider (such as information from a credit reporting company). Such information can include proprietary transaction information, such as from the online seller and/or the payment provider.

According to an embodiment, future creditworthiness can be predicted. For example, future creditworthiness can be predicted by using factors such as likelihood of growth, risk of churning (losing customers), and predictions for the economy generally.

For example, a score can be determined that is representative of an online merchant's future creditworthiness. The score can be based upon industry and/or other factors. The score can be based upon industry standards for success and practices for the particular industry of the online merchant. For example, if the online merchant is a clothing merchant, then the standards can relate to the clothing industry. Thus, inventory levels, inventory costs, labor costs, production costs, shipping costs, and the like can be related to the appropriate industry, e.g., the clothing industry. Such industry related information can be used to determine if a particular online merchant is creditworthy.

The same factors described above to determine creditworthiness can also be used to determine the chum rate of an online merchant. Also, the chum rate of an online merchant can be used, at least in part, to determine the creditworthiness of an online merchant. The term “churn rate” can be defined as the number of payment processing customers lost in a given period of time, e.g., a week, a month, or a year. The higher the churn rate of the online merchant, the lower the creditworthiness of the merchant.

Economic data, either generally or for the particular industry of the online merchant, can be used, at least in part, to determine creditworthiness. The economic data can be used as a baseline. For example, if clothing merchants in general are growing at a rate of 4% per year, then 4% per year can be consider as a nominal or baseline growth rate for clothing selling online merchants. Growth rates greater than 4% per year can be considered good and growth rates less than 4% per year can be consider poor.

According to an embodiment, a loan repayment rate can be used to predict future problems and/or creditworthiness, as is commonly done according contemporary practice. For example, a worsening loan repayment rate can be used to predict future business problems and thus provide an indication of creditworthiness. Thus, online merchant performance can be used, at least in part to determine creditworthiness. The loan repayment rate can be used in combination with other criteria, as discussed herein.

Exemplary applications of apparatuses and methods according to one or more embodiments are described in this section. These examples are being provided solely to add context and aid in the understanding of the embodiments. It will thus be apparent to one skilled in the art that the embodiments may be practiced without some or all of these specific details. In other instances, well known process steps have not been described in detail in order to avoid unnecessarily obscuring the disclosure. Other applications are possible, such that the following examples should not be taken as limiting.

In the following detailed description, references are made to the accompanying drawings, which form a part of the description and in which are shown, by way of illustration, various specific embodiments. Although these embodiments are described in sufficient detail to enable one skilled in the art to practice the embodiments, it is understood that these examples are not limiting, such that other embodiments may be used, and changes may be made without departing from the spirit and scope of the disclosure.

The disclosure relates, in the various described embodiments, to devices, systems and methods involving activities with respect to merchant loan management and processing. In various particular embodiments, the systems or methods can involve one or more user devices in communication over a network. Such a network can facilitate a streamlined process involving merchant loan management and processing.

While the various examples disclosed herein focus on merchant loan management and processing, it will be understood that the various inventive principles and embodiments disclosed herein can be applied to other aspects of electronic commerce, as well.

According to an embodiment, a system can comprise one or more memories. The one or more memories can store sales performance information or the like regarding an online merchant, any other merchant, a customer, or any other entity. One or more hardware processors can be in communication with the one or more memories. The one or more hardware processors can be in communication with the one or more memories via a bus, a network, or by any other means.

The one or more hardware processors can be operable to access the sales performance information in the one or more memories. The one or more hardware processors can be operable to determine, at least in part from the sales performance information, the creditworthiness of the online merchant, any other merchant, a person, or any other entity. The creditworthiness can be determined as discussed herein.

The one or more hardware processors can be operable to send a communication that is indicative of the creditworthiness of the online merchant. The communication can be sent to a person, a device, or anything else. The communication can be sent to a processor or a memory. The communication can be used to approve credit, such as for a loan, for goods, for service, or for any other reason.

The sales performance information comprises seasonal or cyclic sales performance information for the online merchant. For example, the sales of some products vary from one season to another. The sales performance information can use such sales performance information by comparing current seasonal or cyclic sales performance information to seasonal or cyclic sales performance information from one or more previous corresponding periods, such as from previous years. The sales performance information can use such sales performance information by adjusting the seasonal or cyclic sales performance information so that the seasonal or cyclic sales performance information can better be compared to information from different seasons or cycles, such as from the same year.

The sales performance information can comprise one or more merchant ratings for the online merchant. In this manner, customer inputs can be considered in determining a creditworthiness of the online merchant. For example, an online merchant having a better merchant rating can be considered more credit worthy than an online merchant having a worse merchant rating. Thus, better online merchants (who are generally assumed to be more likely to succeed) will have better creditworthiness than worse online merchants (who are generally assumed to be less likely to succeed).

The one or more hardware processors can be further operable to use the sales performance information, at least in part, to determine a likelihood of success for the online merchant. The one or more hardware processors can then be yet further operable to use the likelihood of success for the online merchant, at least in part, to determine the creditworthiness of the online merchant. Thus, the creditworthiness can be based, at least in part, upon the likelihood of success. The likelihood of success can be based upon any desired factors, such as sales, growth rate of sales, number of listings, number of views of listings, conversion rates, repayment of previous loans, and the like.

The one or more hardware processors can be further operable to use the sales performance information, at least in part, to determine a future creditworthiness for the online merchant. The future creditworthiness (e.g., a prediction of the future creditworthiness) for the online merchant can be used, at least in part, to determine the present creditworthiness of the online merchant. Thus, the creditworthiness can be based, at least in part, upon the likelihood of success. The future creditworthiness can be based upon any desired factors, such as sales, growth rate of sales, number of listings, number of views of listings, conversion rates, repayment of previous loans, and the like. The future creditworthiness can be based upon projections such as sales projections, growth rate projections, number of listings projections, number of views of listings projections, conversion rate projections, and the like.

The one or more hardware processors can be operable to receive an inquiry regarding the creditworthiness of the online merchant. The one or more hardware processors can access the sales performance information and determine, at least in part from the sales performance information, the creditworthiness, such as in response to receiving the inquiry.

The one or more hardware processors can be operable to access the sales performance information and determine, at least in part from the sales performance information, the creditworthiness automatically. Thus, the online merchant's creditworthiness can be determined and/or updated automatically. For example, the online merchant's creditworthiness can be determined and/or updated automatically periodically, e.g., daily, weekly, monthly, annually, or according to any other time period.

Alternatively, the online merchant's creditworthiness can be determined and/or updated on demand, such as when the online merchant desires to utilize credit. Thus, the online merchant's creditworthiness can be determined and/or updated in response to a request from the online merchant.

Information available to the system can be used to determine the online merchant's credit worthiness. Information available to the system can be used alone to determine the online merchants credit worthiness. Information available to the system can be used in combination with other information (such as a conventional credit rating) to determine the online merchants credit worthiness.

The methods and/or criteria for determining creditworthiness discussed herein can be combined with one another to determine creditworthiness. For example, both seasonal information and the online merchant rating can be used to determine creditworthiness. The methods and/or criteria for determining creditworthiness discussed herein can be combined with contemporary methods for determining creditworthiness. For example, seasonal information and the online merchant rating can be used in combination with a credit score from a contemporary credit agency.

According to an embodiment, a method can comprise storing, in one or more memories, sales performance information regarding an online merchant. The sales performance information can be accessed, such as electronically by one or more hardware processors, in the one or more memories. The one or more hardware processors can determine, at least in part from the sales performance information, a creditworthiness of the online merchant. The one or more hardware processors can send a communication indicative of the creditworthiness.

According to an embodiment, a computer program product can comprise a non-transitory computer readable medium. The non-transitory computer readable medium can have computer readable and executable code for instructing one or more processors to perform any of the methods disclosed herein.

The one or more memories and one or more hardware processors can be part of the same device, e.g., server. The one or more memories and one or more hardware processors can be part of the different devices, e.g., servers. The one or more memories and one or more hardware processors can be co-located. The one or more memories and one or more hardware processors can be located in different places, e.g., different rooms, different buildings, different cities, or different states.

### Systems and Devices

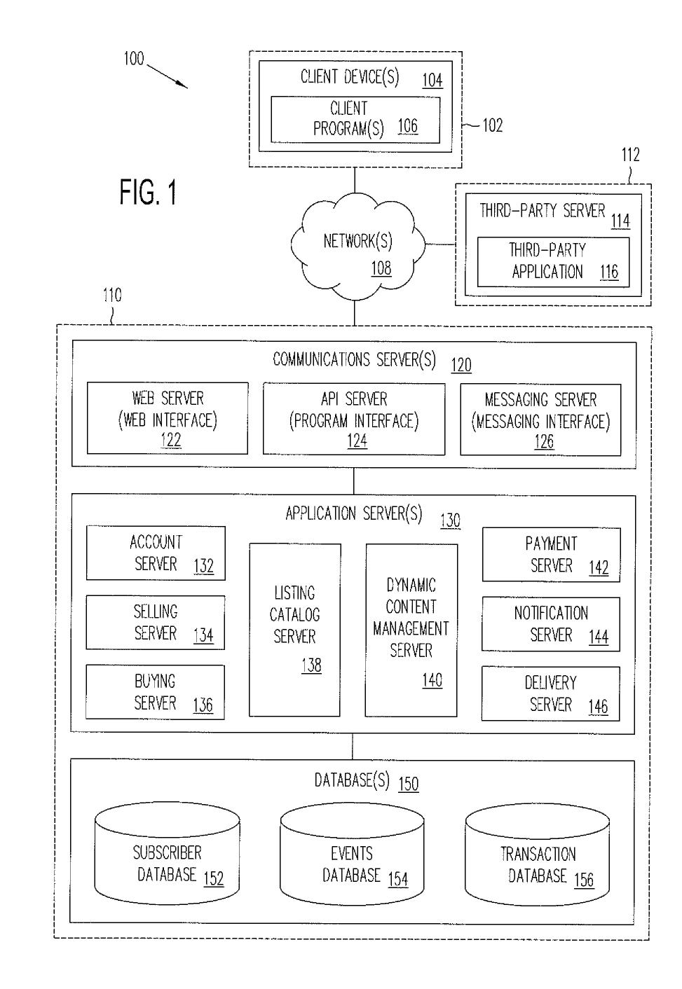

Referring now to FIG. 1, an exemplary embodiment of a computing system adapted for implementing one or more processes involving merchant loan management and processing is illustrated in block diagram format. As shown, computing system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

Computing system 100 can include, among various devices, servers, databases and other elements, a client 102 that may comprise or employ one or more client devices 104, such as a mobile computing device, a PC, and/or any other computing device having computing and/or communications capabilities in accordance with the described embodiments. Client devices 104 generally may provide one or more client programs 106, such as system programs and application programs to perform various computing and/or communications operations. Exemplary system programs may include, without limitation, an operating system (e.g., MICROSOFT® OS, UNIX® OS, LINUX® OS, Symbian OS™, Embedix OS, Binary Run-time Environment for Wireless (BREW) OS, JavaOS, a Wireless Application Protocol (WAP) OS, and others), device drivers, programming tools, utility programs, software libraries, application programming interfaces (APIs), and so forth. Exemplary application programs may include, without limitation, a web browser application, messaging applications (e.g., e-mail, IM, SMS, MMS, telephone, voicemail, VoIP, video messaging), contacts application, calendar application, electronic document application, database application, media application (e.g., music, video, television), location-based services (LBS) application (e.g., GPS, mapping, directions, point-of-interest, locator), and so forth. One or more of client programs 106 may display various graphical user interfaces (GUIs) to present information to and/or receive information from one or more of client devices 104.

As shown, client 102 can be communicatively coupled via one or more networks 108 to a network-based system 110. Network-based system 110 may be structured, arranged, and/or configured to allow client 102 to establish one or more communications sessions with network-based system 110 using various computing devices 104 and/or client programs 106. Accordingly, a communications session between client 102 and network-based system 110 may involve the unidirectional and/or bidirectional exchange of information and may occur over one or more types of networks 108 depending on the mode of communication. While the embodiment of FIG. 1 illustrates a computing system 100 deployed in a client-server operating environment, it is to be understood that other suitable operating environments and/or architectures may be used in accordance with the described embodiments.

Data and/or voice communications between client 102 and the network-based system 110 may be sent and received over one or more networks 108 such as the Internet, a WAN, a WWAN, a WLAN, a mobile telephone network, a landline telephone network, a VoIP network, as well as other suitable networks. For example, client 102 may communicate with network-based system 110 over the Internet or other suitable WAN by sending and or receiving information via interaction with a web site, e-mail, IM session, and/or video messaging session. Any of a wide variety of suitable communication types between client 102 and system 110 can take place, as will be readily appreciated.

In various embodiments, computing system 100 can include, among other elements, a third party 112, which may comprise or employ a third-party server 114 hosting a third-party application 116. In various implementations, third-party server 314 and/or third-party application 116 may host a web site associated with or employed by a third party 112. For example, third-party server 114 and/or third-party application 116 may enable network-based system 110 to provide client 102 with additional services and/or information, such as merchant loan management and processing. In some embodiments, one or more of client programs 106 may be used to access network-based system 110 via third party 112. For example, client 102 may use a web client to access and/or receive content from network-based system 110 after initially communicating with a third-party web site 112.

Network-based system 110 may comprise one or more communications servers 120 to provide suitable interfaces that enable communication using various modes of communication and/or via one or more networks 108. Communications servers 120 can include a web server 122, an API server 124, and/or a messaging server 126 to provide interfaces to one or more application servers 130. Application servers 130 of network-based system 110 may be structured, arranged, and/or configured to provide various merchant loan management and processing services to users that access network-based system 110. In various embodiments, client 102 may communicate with applications servers 130 of network-based system 110 via one or more of a web interface provided by web server 122, a programmatic interface provided by API server 124, and/or a messaging interface provided by messaging server 126. It can be appreciated that web server 122, API server 124, and messaging server 126 may be structured, arranged, and/or configured to communicate with various types of client devices 104 and/or client programs 106 and may interoperate with each other in some implementations.

Web server 122 may be arranged to communicate with web clients and/or applications such as a web browser, web browser toolbar, desktop widget, mobile widget, web-based application, web-based interpreter, virtual machine, and so forth. API server 124 may be arranged to communicate with various client programs 106 and/or a third-party application 116 comprising an implementation of API for network-based system 110. Messaging server 126 may be arranged to communicate with various messaging clients and/or applications such as e-mail, IM, SMS, MMS, telephone, VoIP, video messaging, and so forth, and messaging server 126 may provide a messaging interface to enable access by client 102 and/or third party 112 to the various services and functions provided by application servers 130.

When implemented as an merchant loan management and processing system, application servers 130 of network-based system 110 may provide various online marketplace and electronic commerce services including, for example, account services, buying services, selling services, listing catalog services, dynamic content management services, delivery services, payment services, and notification services. Application servers 130 may include an account server 132, a buying server 134, a selling server 136, a listing catalog server 138, a dynamic content management server 140, a payment server 142, a notification server 144, and/or a delivery server 146 structured and arranged to provide merchant loan management and processing services.

Application servers 130, in turn, may be coupled to and capable of accessing one or more databases 150 including a subscriber database 152, an active events database 154, and/or a transaction database 156. Databases 150 generally may store and maintain various types of information for use by application servers 130 and may comprise or be implemented by various types of computer storage devices (e.g., servers, memory) and/or database structures (e.g., relational, object-oriented, hierarchical, dimensional, network) in accordance with the described embodiments.

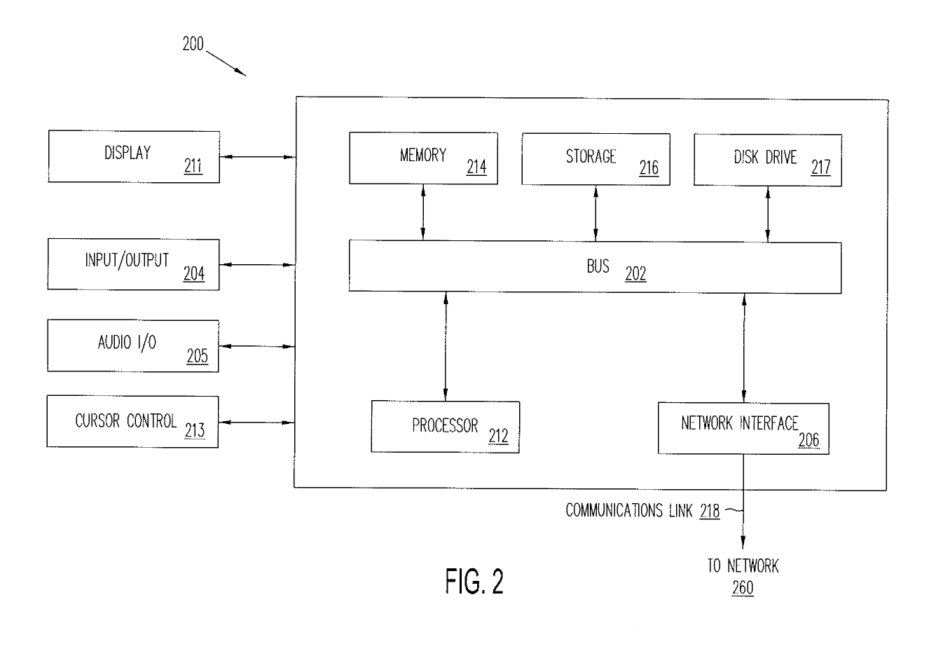

Continuing with FIG. 2, an exemplary computer system 200 suitable for implementing on one or more devices of the computing system in FIG. 1 is depicted in block diagram format. In various implementations, a device that includes computer system 200 may comprise a personal computing device (e.g., a smart phone, a computing tablet, a personal computer, laptop, PDA, Bluetooth device, key FOB, badge, etc.) that is capable of communicating with a network. The merchant loan management and processing system and/or a payment provider may utilize a network computing device (e.g., a network server) capable of communicating with the network. It should be appreciated that each of the devices utilized by users, the merchant loan management and processing system, and the payment providers may be implemented as computer system 200 in a manner as follows.

Computer system 200 can include a bus 202 or other communication mechanism for communicating information data, signals, and information between various components of computer system 200. Components include an input/output (I/O) component 204 that processes a user action, such as selecting keys from a keypad/keyboard, selecting one or more buttons or links, etc., and sends a corresponding signal to bus 202. I/O component 204 may also include an output component, such as a display 211 and a cursor control 213 (such as a keyboard, keypad, mouse, etc.). An optional audio input/output component 205 may also be included to allow a user to use voice for inputting information by converting audio signals. Audio I/O component 205 may allow the user to hear audio. A transceiver or network interface 206 transmits and receives signals between computer system 200 and other devices, such as another user device, a merchant server, or a payment provider server via a network. In an embodiment, the transmission is wireless, although other transmission mediums and methods may also be suitable. A processor 212, which can be a micro-controller, digital signal processor (DSP), or other processing component, processes these various signals, such as for display on computer system 200 or transmission to other devices over a network 260 via a communication link 218. Processor 212 may also control transmission of information, such as cookies or IP addresses, to other devices.

Components of computer system 200 also include a system memory component 214 (e.g., RAM), a static storage component 216 (e.g., ROM), and/or a disk drive 217. Computer system 200 performs specific operations by processor 212 and other components by executing one or more sequences of instructions contained in system memory component 214. Logic may be encoded in a computer readable medium, which may refer to any medium that participates in providing instructions to processor 212 for execution. Such a medium may take many forms, including but not limited to, non-volatile media, volatile media, and transmission media. In various implementations, non-volatile media includes optical or magnetic disks, volatile media includes dynamic memory, such as system memory component 214, and transmission media includes coaxial cables, copper wire, and fiber optics, including wires that comprise bus 202. In an embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments, execution of instruction sequences for practicing the embodiments may be performed by a computer system. In various other embodiments, a plurality of computer systems coupled by a communication link (e.g., LAN, WLAN, PTSN, or various other wired or wireless networks) may perform instruction sequences to practice the embodiments in coordination with one another. Modules described herein can be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa—for example, a virtual Secure Element (vSE) implementation or a logical hardware implementation.

Software, in accordance with the present disclosure, such as program code and/or data, may be stored on one or more computer readable and executable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

### Merchant Loan Management and Processing

As will be readily appreciated, the foregoing networks, systems, devices, and numerous variations thereof can be used to implement a system for merchant loan management and processing. The system can be used, for example, to determine the creditworthiness of a merchant, such as an online merchant. The system can be used, for example, to determine the creditworthiness by an online seller, such as eBay, and/or by a payment provider, such as PayPal or Bill Me Later.

Information readily available to the online seller and/or payment provider can be used to facilitate the determination of creditworthiness. Information readily available in one or more databases of the online seller and/or payment provider can be used to facilitate the determination of creditworthiness. For example, such information can include a sales history, a payment history, account information, and/or any other information that is acquired, such as routinely acquired, by the online seller and/or payment provider.

As noted with respect to FIG. 2 above, a computer system 200 can include one or more processors 212 and one or more memories or storage devices 214, 216. Such a computer system 200 can be part of a user device, part of one or more servers on a network-based system, or some combination thereof. In particular, a given computing system can include a first memory device or storage component adapted to store information regarding one or more users of the system, as well as a second memory device or storage component adapted to store information regarding an online merchant.

In addition, one or more processors 212 can be adapted to facilitate merchant loan management and processing, e.g., determining creditworthiness. Further functionality of the one or more processors 212 can include facilitating any desired functionality.

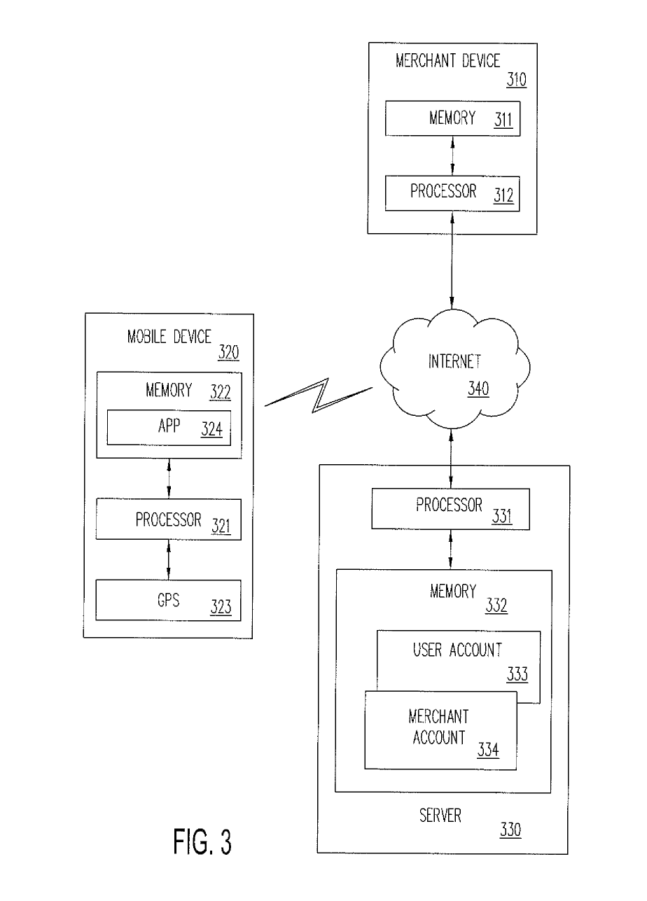

FIG. 3 is a block diagram of a system for merchant loan management and processing, according to an embodiment. The system can include a merchant device 310, a mobile device 320, and/or a server 330. The functions and components discussed herein can be split and/or shared among the merchant device 310, the mobile device 320, the server 330, and/or any other devices or systems, as desired. The merchant device 310 can be a device of an online merchant and/or can be a device of a brick-and-mortar merchant.

The merchant device 310 can comprise a merchant checkout terminal, a computer, and/or a server, for example. The merchant device 310 can include a memory 311 and a processor 312. The merchant device 310 can be used for processing purchases from the merchant. The merchant device 310 can be used for merchant loan management and processing. For example, the merchant device 310 can be used to request a loan and/or to initiate determination of the credit worthiness of the online merchant. As a further example, the merchant device 310 can provide information, such as sales performance information, that can be used by the system in determining creditworthiness.

The mobile device 320 can be carried by the user. The mobile device 320 can comprise a cellular telephone, a smart telephone, a hand held computer, a laptop computer, a notebook computer, or a tablet computer, for example. The mobile device 320 can include a processor 321, a memory 322, and a global positioning system (GPS) 323. The GPS 323 can provide information regarding a location of the online merchant or an owner of the online merchant. Such location information can be used, at least in part, to determine creditworthiness. For example, online merchant owners who spend a substantial amount of time in some countries (such as countries that are unfriendly with respect to the United States) can be considered less creditworthy.

The mobile device 320 can be used for routine telephone calls, text messaging, web browsing, and the like. The mobile device 320 can be used for merchant loan management and processing. For example, the mobile device 320 can be a mobile device of the online merchant or of a person associated with the online merchant. For example, the mobile device 320 can be used to request a loan and/or to initiate determination of the credit worthiness of the online merchant. As a further example, the mobile device 320 can provide information, such as sales performance information, that can be used by the system in determining creditworthiness.

An app 324 can be stored in the memory 322 and executed by the processor 321. The app 324 can be used for merchant loan management and processing, e.g. for initiating determination of the credit worthiness of the online merchant.

The server 330 can comprise a server of a payment provider, such as PayPal, Inc. Thus, the server 330 can be a payment server. The server 330 can be a single server or can be a plurality of servers. The server 330 can include one or more processors 331 and a memory 332. The memory 332 can be a memory of the server 330 or a memory that is associated with the server 330. The memory 332 can be a distributed memory. The memory 332 can store a user account 333 and a merchant account 334. The memory 332 can contain one or more databases. The memory 332 can contain sale performance information for the online merchant. For example, the memory 332 can be a memory of an online seller or a payment provider that contains information regarding transactions (such as sales transactions and/or financial transactions) of the online merchant.

The server 330 can be used for merchant loan management and processing, e.g. for determining the credit worthiness of the online merchant. Thus, the methods describe herein can be performed, for example, by the server 330.

Generally, the merchant device 310, the mobile device 320, and the server 330 can perform functions discussed herein. That is, at least to some extent, a function that is discussed herein as being performed via a particular one of these devices can be performed by a different one of these devices, by a combination of these devices, and/or by other devices.

The merchant device 310, the mobile device 320, and the server 330 can communicate with one another via a network, such as the Internet 340. The merchant device 310, the mobile device 320, and the server 330 can communicate with one another via one or more networks, such as local area networks (LANs), wide area networks (WANs), cellular telephone networks, and the like. The merchant device 310, the mobile device 320, and the server 330 can communicate with one another, at least partially, via one or more near field communications (NFC) methods or other short range communications methods, such as infrared (IR), Bluetooth, WiFi, and WiMax.

### Methods

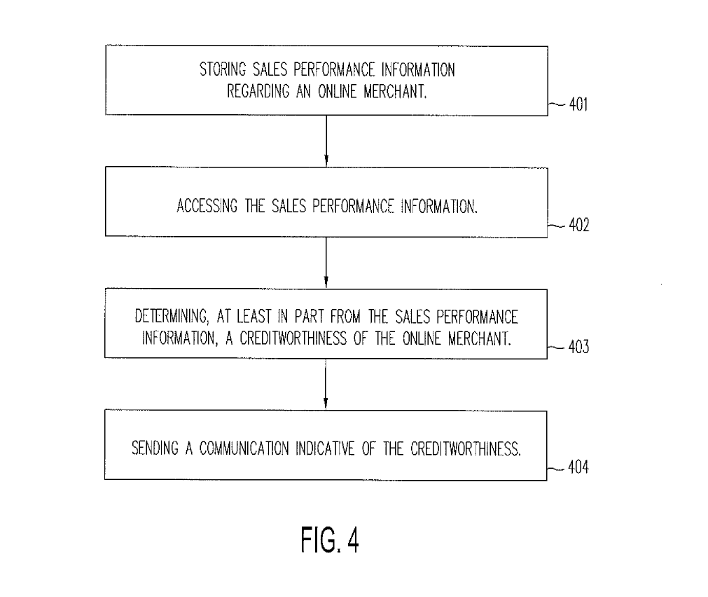

FIG. 4 is a flow chart that describes an example of operation of the system for merchant loan management and processing according to embodiments thereof. Note that one or more of the steps described herein may be combined, omitted, or performed in a different order, as desired or appropriate.

Sales performance information can be stored, as shown in step 401. The sales performance information can be stored in one or more memories, such as memory 332 of server 330. The sales performance information can be information regarding one or more online merchants. For example, the sales performance information can include a sales history, a listing history, a listings viewed history, and any other information regarding sales, attempted sales, and/or prospective sales of the online merchant. The sales performance information can include any information that can be used to determine a creditworthiness of the online merchant.

One or more hardware processors can be in communication with the one or more memories and operable to perform various steps regarding merchant loan management and processing. For example, the one or more hardware processors 331 of server 330 can be operable to access the sales performance information, as shown in step 402.

The one or more hardware processors can be operable to determine, at least in part from the sales performance information, a creditworthiness of the online merchant, as shown in step 403. The creditworthiness can be determined using only the sales performance information. The creditworthiness can be determined using any desired information. For example, the creditworthiness can be determined using information from a credit reporting company (such as a contemporary credit rating) in combination with the sales performance information.

The one or more hardware processors can be operable to send a communication indicative of the creditworthiness, as shown in step 404. The communication can be sent to a device, system, or a person. The information can be used, at least in part, to authorize, deny, or modify a loan of the online merchant. The communication can include providing a loan to the online merchant.

In one embodiment, the loan (newly authorized or modification of a current loan) is a close-ended (fixed amount) loan based on expected customer sales, with no fixed duration and is provided with no end or due date and no interest is provided to merchants. The “loan” may be viewed as a hybrid cash advance/loan product. In other embodiments, the loan can be a traditional loan or any other suitable loan product, where terms and amounts can be varied based on the determined creditworthiness of the merchant.

In one embodiment, the online merchant picks an amount to borrow up to a maximum amount and selects a percentage of future sales using sales through the payment provider service for repayment. The amount can be limited to the creditworthiness of the merchant as described herein. A single fixed fee is assessed (based on the amount, repayment percentage, past business sales volumes, risk score, and/or creditworthiness), such that the merchant repays more than the loan amount. There are no additional fees (no origination, utilization, pre-payment late fees, or any other fees). The fee amount is known by merchant before loan amount is funded. At fixed times daily, the selected percentage of the merchant's previous day sales is moved to repayment until the loan amount plus the fee amount are paid in full. Merchants can make ad hoc payments if they wish with no penalty. In one embodiment, the balance must be paid in full (zero balance) before a second loan can be funded.

The one or more memories and/or the one or more processors can be one or more memories and/or the one or more processors of the merchant device 310, the user device 320, the server 330, the social network 350, and/or any other device or system. Memories and/or processors from any number of devices, systems, and entities can cooperate to perform the merchant loan management and processing method disclosed herein.

In implementation, at least some of the various embodiments may comprise a personal computing device, such as a personal computer, laptop, PDA, cellular phone or other personal computing or communication devices. The payment provider system may comprise a network computing device, such as a server or a plurality of servers, computers, or processors, combined to define a computer system or network to provide the payment services provided by a payment provider system.

In this regard, a computer system may include a bus or other communication mechanism for communicating information, which interconnects subsystems and components, such as a processing component (e.g., processor, micro-controller, digital signal processor (DSP), etc.), a system memory component (e.g., RAM), a static storage component (e.g., ROM), a disk drive component (e.g., magnetic or optical), a network interface component (e.g., modem or Ethernet card), a display component (e.g., CRT or LCD), an input component (e.g., keyboard or keypad), and/or cursor control component (e.g., mouse or trackball). In an embodiment, a disk drive component may comprise a database having one or more disk drive components.

The computer system may perform specific operations by a processor and executing one or more sequences of one or more instructions contained in a system memory component. Such instructions may be read into the system memory component from another computer readable medium, such as static storage component or disk drive component. In other embodiments, hard-wired circuitry may be used in place of or in combination with software instructions to implement the embodiments.

Payment processing can be through known methods, such as transaction details being communicated to the payment provider through the app, the payment provider processing the details, which may include user account and identifier information and authentication, merchant information, and transaction details. The user account may be accessed to determine if any restrictions or limitations may prevent the transaction from being approved. If approved, the payment provider may send a notification to the merchant and/or the user.

As used herein, the term “risk of failure” can include failure of a business and/or failure to repay a loan.

As used herein, the term, “sales performance information” can include any information that is indicative of creditworthiness. Such information can relate, either directly or indirectly, to the business of a merchant, such as to sales of the merchant. For example, such information can relate to the sales, returns, merchant ratings, quality, earnings, losses, debts, stock process, profits, taxes, or any other measure of business performance. Such information can relate to any combination or rate of change of such items.

Such information can relate to proxy information with respect to the business of the merchant. For example, such information can relate to personal purchases of owners of the online merchant. If the owners if the online merchant are making expensive purchases, then it can sometimes be inferred that the online merchant is prospering. However, other factors, such as debt and rate of debt increase, can be particularly important when relying, to some extent, upon such proxy information.

As used herein, the term “store” can include any business or place of business. The store can be a brick and mortar store or an online store. Examples of stores can include supermarkets, discount stores, book stores, convenience stores, restaurants, gas stations, auto repair shops, and movie theaters. The store can be any person or entity that sells a product and/or provides a service.

As used herein, the term “product” can include any item or service. Thus, the term “product” can refer to physical products, digital goods, services, or anything for which a user can make a payment, including charitable donations. A product can be anything that can be sold. Examples of products include cellular telephones, concerts, meals, hotel rooms, automotive repair, haircuts, digital music, and books. The product can be a single item or a plurality of items. For example, the product can be a tube of toothpaste, a box of laundry detergent, three shirts, and a donut.

As used herein, the term “merchant” can include any seller of products. The term merchant can include a store. The products can be sold from a store or in any other manner.

As used herein, the term “online merchant” can include any seller of products online. The term can include any individual (such as a sole proprietor), group of individuals (such as a partnership), any company, corporation, or the like.

As used herein, the term “online seller” can include a business entity that facilitates online sales for online merchants. The online seller can provide the infrastructure for listing ads, selling products, shipping, providing online seller reviews, and the like. One example of such an online seller is eBay Inc. of San Jose, Calif.

As used herein, the term “mobile device” can include any portable electronic device that can facilitate data communications, such as via a cellular network and/or the Internet. Examples of mobile devices include cellular telephones, smart phones, tablet computers, and laptop computers.

As used herein, the term “network” can include one or more local area networks (LANs) such as business networks, one or more wide area networks (WANs) such as the Internet, one or more cellular telephone networks, or any other type or combination of electronic or optical networks.

As used herein, the term “card” can refer to any card or other device that can be used to make a purchase in place of cash. For example, the card can be a bank card, credit card, debit card, gift card, or other device. The card can be a token, such as a hardware token or a software token. The card can be stored in and/or displayed upon a user device, such as a cellular telephone.

The foregoing disclosure is not intended to limit the disclosure to the precise forms or particular fields of use disclosed. It is contemplated that various alternate embodiments and/or modifications, whether explicitly described or implied herein, are possible in light of the disclosure. Having thus described various example embodiments of the disclosure, persons of ordinary skill in the art will recognize that changes may be made in form and detail without departing from the scope of the disclosure. Thus, the disclosure is limited only by the claims.

1. A system comprising:
one or more memories storing sales performance information regarding an online merchant;
one or more hardware processors in communication with the one or more memories and operable to:
access the sales performance information in the one or more memories;
determine, at least in part from the sales performance information, a creditworthiness of the online merchant, wherein the creditworthiness is determined based, at least in part, on one or more traits the online merchant has in common with one or more merchants who have at least one of a higher sales volume, a lower debt, and a higher profit return; and
send a communication indicative of the creditworthiness.

2. The system of claim 1, wherein the sales performance information comprises seasonal or cyclic sales performance information for the online merchant.

3. The system of claim 1, wherein the sales performance information comprises a merchant rating for the online merchant.

4. The system of claim 1, wherein the one or more hardware processors are further operable to:
use the sales performance information, at least in part, to determine a likelihood of success for the online merchant; and
use the likelihood of success for the online merchant, at least in part, to determine the creditworthiness of the online merchant.

5. The system of claim 1, wherein determining the creditworthiness of the online merchant comprises predicting a future creditworthiness of the online merchant.

6. The system of claim 1, wherein the creditworthiness is determined, at least in part, based on one or more traits the online merchant has in common with one or more failed merchants similar to the online merchant.

7. The system of claim 1, wherein credit or a loan is provided to the online merchant based on the creditworthiness.

8. The system of claim 1, wherein the one or more hardware processors is further operable to determine creditworthiness based on a plurality of repayment amounts from the online merchant.

9. The system of claim 8, wherein the repayment amounts are for a fixed percentage of sales for the merchant.

10. A method comprising:
accessing, electronically by one or more hardware processors, sales performance information in one or more memories;
determining, electronically by the one or more hardware processors and at least in part from the sales performance information, a creditworthiness of the online merchant, wherein the creditworthiness is determined based, at least in part, on one or more traits the online merchant has in common with one or more merchants who have at least one of a higher sales volume, a lower debt, and a higher profit return; and
sending, electronically by the one or more hardware processors, a communication indicative of the creditworthiness.

11. The method of claim 10, wherein the sales performance information comprises seasonal or cyclic sales performance information for the online merchant.

12. The method of claim 10, wherein the sales performance information comprises a merchant rating for the online merchant.

13. The method of claim 10, further comprising:
using the sales performance information, at least in part, to determine a likelihood of success for the online merchant; and
using the likelihood of success for the online merchant, at least in part, to determine the creditworthiness of the online merchant.

14. The method of claim 10, wherein determining the creditworthiness of the online merchant comprises predicting a future creditworthiness of the online merchant.

15. The method of claim 10, wherein the creditworthiness is determined, at least in part, based on one or more traits the online merchant has in common with one or more failed merchants similar to the online merchant.

16. The method of claim 10, wherein credit or a loan is provided to the online merchant based on the creditworthiness.

17. The method of claim 10, wherein the one or more hardware processors is further operable to determine creditworthiness based on a plurality of repayment amounts from the online merchant.

18. The method of claim 10, wherein the repayment amounts are for a fixed percentage of sales for the merchant.

19. A computer program product comprising a non-transitory computer readable medium having computer readable and executable code for instructing one or more processors to perform a method, the method comprising:
accessing sales performance information;
determining, at least in part from the sales performance information, a creditworthiness of the online merchant, wherein the creditworthiness is determined based, at least in part, on one or more traits the online merchant has in common with one or more merchants who have at least one of a higher sales volume, a lower debt, and a higher profit return; and
sending a communication indicative of the creditworthiness.

20. The computer program product of claim 19, wherein the sales performance information comprises seasonal or cyclic sales performance information for the online merchant.

21. The computer program product of claim 19, further comprising:
using the sales performance information, at least in part, to determine a likelihood of success for the online merchant; and
using the likelihood of success for the online merchant, at least in part, to determine the creditworthiness of the online merchant.

22. The computer program product of claim 19, wherein determining the creditworthiness of the online merchant comprises predicting a future creditworthiness of the online merchant.
